(19) United States
(12) Patent Application Publication
(10) Pub. No.: US 2017/0171327 A1
(43) Pub. Date: Jun. 15, 2017

(54) Computerized System for Providing a Smart Address Book and Methods of Its Use

(71) Applicant: Yakov Z. Mermelstein, Spring Valley, NY (US)

(72) Inventor: Yakov Z. Mermelstein, Spring Valley, NY (US)

(21) Appl. No.: 15/214,640

(22) Filed: Jul. 20, 2016

Related U.S. Application Data
(60) Provisional application No. 62/195,126, filed on Jul. 21, 2015.

(51) Int. Cl. H04L 29/08; H04W 4/02; H04L 29/12

(52) U.S. Cl. CPC H04L 67/24; H04L 61/1594; H04L 67/306; H04W 4/023

(57) ABSTRACT

A smart address book enabling real-time status updates to a user regarding contacts with the address book. The status updates may be performed automatically and reflect preferences defined by the user and/or the contact. The smart address book has additional functionality that enables one-click calling of a contact utilizing the contact's real-time status as well as dynamic caller ID.

### CROSS-REFERENCE TO RELATED PATENT APPLICATION

This patent application claims a benefit to the Jul. 21, 2016 filing date of U.S. Provisional Patent Application Ser. No. 62/195,126 titled “Computerized System for Providing a Smart Address Book and Methods of Its Use.” The disclosure of U.S. 62/195,126 is incorporated by reference herein in its entirety.

### BACKGROUND

Communication technology has made it possible to contact another person at essentially any time from essentially any place. Users even have the luxury of choosing how they would like to send a message and how that message should be received, whether it be through a phone, text message, instant message, social media service, or other electronic application.

However, one aspect of traditional human-to-human communication has thus far lagged behind in terms of innovation. Users still use address books to store information related to their contacts. Even though these address books may have gone electronic, the concept of a list of people and places with associated contact information is essentially unchanged from its humble pen and paper beginnings. Despite having unprecedented power to communicate with others at great distances, traditional address books are static and provide no context to the user. A contact's phone may be off, the contact may be engaged at a meeting at work, the contact may be attending a concert, and an individual would have no way of knowing that their contact is unavailable until an attempt to reach that contact fails. The inability of the user to immediately determine why the contact request failed may also lead to unnecessary stress, for example when a parent cannot contact their child, where the child may simply be attending an event at school but the parent fears the child may be in danger.

The result is a user-to-user communication experience that can often prove frustrating, with ample time wasted on communications that never had a chance of succeeding and unfounded concerns about why that was the case. Traditional social media services such as instant messaging services and Facebook® (Facebook, Inc., Menlo Park, Calif.) allow for the manual setting of a status, however the accuracy of that status depends solely on the user's dedication to keep the status up to date, and further has no bearing on the behavior of other services (e.g. changing a status on an instant messaging service to “busy” does nothing to dissuade a user from attempting contact by phone). There is a need, therefore, for a smart address book that can inform its user as to the status of the contacts held therein and enable the user to make an informed decision about establishing communication with those contacts.

Exemplary hardware components for implementing the systems and methods of the present disclosure are generally identified in United States Patent Application Publications US 2013/0254233 and US 2011/0238755, each of which are incorporated herein by reference in their entireties.

### DESCRIPTION

In some embodiments, the computerized system of the present disclosure is directed to a contextual address book that incorporates location, calendar, usage, movement, and other relevant data of the computerized system users and the contacts associated with those users to provide contextual services.

In some embodiments, the present disclosure is directed to a computerized system for providing a real-time address book using coordinated electronic components comprising at least one user, wherein the at least one user has a personal electronic mobile device. In some embodiments, the personal electronic mobile device is selected from the group consisting of a smart phone, a PDA, a laptop, a tablet computer, and the like. In some embodiments, the systems and methods of the present disclosure are implemented on a desktop computer.

In some embodiments, the computerized system further comprises at least one server comprising software for managing user related information and analyzing user activity data. In some embodiments, user related information includes general personal information such as name, address, contact information, and the like. In some embodiments, user related information includes user defined preferences for functionality of the computerized system, as will be discussed in greater detail below. In some embodiments, user activity data includes information about what the user is doing. In some embodiments, this includes location information, electronic calendar information, and other information captured by at least one sensor for collecting data, which will also be discussed in greater detail below.

In some embodiments, the computerized system includes a profile comprising at least some of the user related information and a user status. In some embodiments, the profile is viewable by other users of the computerized system. The profile allows each user of the computerized system to identify a status of the other users of the computerized system so that each user is capable of making informed decisions about contacting other users.

In some embodiments, the computerized system includes at least one sensor for collecting user activity data and uploading the user activity to the at least one server, as well as software executing on a computer readable medium for updating the user status in response to analyzed user activity data gathered from the at least one sensor. The user's profile is then viewable by other users of the computerized system.

The computerized system of the present disclosure thusly overcomes the deficiencies of traditional address books. Users of the address book are given real-time status information along with contact information when viewing contacts, thus enabling the user to make an informed decision about whether to attempt to communicate with that contact and/or to have some context as to why an attempted communication was not accepted.

As discussed above, in some embodiments, the computerized system employs at least one sensor to gather activity data related to a user. In some embodiments, the at least one sensor includes a phone module, a global positioning system (GPS), a gyroscope, an accelerometer, a magnetometer, a Wi-Fi module, a Bluetooth® (Bluetooth Sig, Kirkland, Wash.) module, a near-field communication (NFC) module, electronic calendar, and combinations thereof. The phone module allows the computerized system to determine whether the user is currently on the phone or whether the user is reachable by phone, allowing the computerized system to update the user status accordingly. In some embodiments, the computerized system also monitors additional phone modules and other sensors attached to other communication devices to determine the user status. For example, for a user profile identifying both a home phone and a mobile phone identified in their profile, accepting or placing a call using either will prompt the computerized system to update the user status. GPS allows the computerized system to determine the location of the user, information which can be analyzed to update a status of the user. As used herein, the terms global positioning system and GPS are used interchangeably and are defined to include general global positioning systems and methods in addition to specific systems and methods such as Beidou (satellite navigation system operated by China), Galileo (satellite navigation system operated by the European Union), Glonass (satellite navigation system operated by Russia), and the like. Gyroscopes and accelerometers (also referred to herein as “motion sensors”) are capable of determining whether or not a user is in motion, and thus whether the user is engaging in an activity that should result in a status update. In some embodiments, the motion sensors are used to determine a user's location within a building through step counting and direction identification as discussed in International Patent Application No. PCT/US15/25042, which is incorporated herein by reference in its entirety. In some embodiments, the computerized system is also able to obtain location-based data about a user by recognizing a location of the user relative to a known location of another user or object. This embodiment includes sensors such as magnetometers, Wi-Fi, Bluetooth®, and NFC modules, which allow for the computerized system to acquire location data about the user, either in addition to or in lieu of GPS sensor data. Finally, electronic calendar information can be used to inform the computerized system about scheduled events that could affect a user's status. In some embodiments, the computerized system updates a user's status to reflect attendance at a scheduled event even if the computerized system cannot confirm that the user is at the event. For example, if a user's personal electronic mobile device is turned off, the computerized system may have no way to directly identify the user at a meeting. However, the computerized system may instead identify 4 other users who are also supposed to attend that meeting. Should the computerized system identify that the other 4 users are in attendance at the meeting, the computerized system updates the user's status under the assumption that the meeting is proceeding as scheduled and that the user is most likely to be in attendance as planned.

Also as discussed above, a user's status is updated in response to analyzed user activity data gathered by the at least one sensor. In some embodiments, a user's status is updated automatically in response to a perceived change in the activity data recently gathered by the at least one sensor. In some embodiments, the automatic update of the user's status is based on user defined preferences for how a status should be identified in light of certain activity data. In some embodiments, the automatic update is based on crowd-sourced preferences for how a status should be identified in light of certain activity data. For example, the computerized system may recognize that the vast majority of users have set preferences to change a user status to “BUSY” when within a hospital. Therefore, the default user status for a user that has yet to set a preference for a hospital would be “BUSY” until a separate user preference was defined. In some embodiments, user preferences for user status updates only take effect after a predetermined period of time has passed. In some embodiments, the predetermined period of time is at least 1 hour, at least 5 hours, at least 12 hours, or at least 24 hours. The delay in switching user preferences discourages users from changing user preferences in an effort to force the computerized system to identify an inaccurate status. For business applications, this limitation is particularly useful as it inspires greater confidence that the status of a given user is accurate and consistent. In some embodiments, user status is set manually but with a timer. In these embodiments, a user status is manually set for a predetermined amount of time, at the end of which the user status is updated as described elsewhere in the present disclosure. In some embodiments, user status is set manually and then changes in response to a change in user activity data. For example, upon entering a shopping center a user manually sets the user status to “BUSY”. Once the user subsequently leaves the shopping center, as identified by the at least one sensor, the user status then updates as described elsewhere in the present disclosure.

In some embodiments, the computerized system comprises a graphic user interface (GUI) operating on the personal electronic mobile device for displaying the profile to other users. The GUI displays the actual user status and user related information to the other users of the computerized system. The user status identified by the computerized system can be as specific or generic as desired. In some embodiments, the specificity of the user status is a preference defined manually by the user. Generic user statuses include terms such as “BUSY”, “AVAILABLE”, “OUT OF OFFICE”, and the like. More specific user statuses include specific location information, such as “AT THE LIBRARY” or “AT MCDONALD'S”, as well as “ON A RUN”, “ON THE PHONE”, or “DRIVING IN MY CAR”.

As discussed above, in some embodiments, the phone module allows the computerized system to determine whether the user is currently on the phone or whether the user is reachable by phone, allowing the computerized system to update the user status accordingly. In some embodiments, the computerized system recognizes that a user is on the phone and updates the user status to a generic term such as “BUSY”. In some embodiments, the computerized system updates the user status using a more specific description, such as “ON THE PHONE WITH [INSERT CONTACT NAME]”. In some embodiments, the computerized system recognizes the number in communication with the user's phone module and updates a profile including that number. In some embodiments, that number is included in a profile for a contact that is not a user of the computerized system. In some embodiments, that contact's profile is temporary. In some embodiments, that contact's profile persists so long as the number remains in the address book of more than one user.

In some embodiments, the user status is set according to user activity data received by GPS or other location sensing sensors, such as Wi-Fi, Bluetooth®, and NFC. As described above, the user status may be generic or specific depending on the preferences of the user. For example, upon recognition that the user left his or her work building and is now in a restaurant having lunch, the computerized system may update the user status to messages such as “OUT OF OFFICE”, “OUT TO LUNCH”, or “AT [INSERT RESTAURANT NAME]”. In some embodiments, the GPS identifies that the user is in a specific location, such as a certain restaurant, a movie theater, or a concert venue. In response, the computerized system updates the user status according to user preferences for these locations. In some embodiments, GPS sensors combine with other sensors to provide even more specific user status updates, as will be described below in greater detail.

In some embodiments, the user status is set according to user activity data received from an electronic calendar, which can identify scheduled events for the user and use that information to alert other users to the activities of that user. For example, a user inputs to the electronic calendar that they are attending a wedding on Saturday, July 18, from 5 PM until 11 PM. Without needing to update his or her profile, the user status will automatically update to “BUSY” starting at 5 PM and revert back to “AVAILABLE” at 11 PM. In some embodiments, grace periods are incorporated into the electronic calendar events. For example, in the case of the wedding identified above, the computerized system may set the user status to “BUSY” at 4:30 PM and revert back to “AVAILABLE” at 11:30 PM to the give the user time to transition from “AVAILABLE” to at the wedding and back again. As described above, in some embodiments, the user status is more specific. For example, when a user's calendar indicates a meeting with a client out of the office, the user status may be updated to read “BUSY” or “OUT OF THE OFFICE FOR MEETING WITH A CLIENT”. In some embodiments, the computerized system is alerted that the user has booked a plane ticket and is scheduled to depart at a predetermined time. The computerized system therefore knows to set the user status to “BUSY” during the duration of the flight. In some embodiments, the computerized system leaves the user status as “BUSY” until the user's personal electronic mobile device reconnects with the computerized system after the flight arrives. In some embodiments, the computerized system leaves the user status as “BUSY” until other users known to be on that flight reconnect with the computerized system, even if the user's personal electronic mobile device does not reconnect at the same time.

In some embodiments, the computerized system also interfaces with timing systems at the user's workplace. In this embodiment, whether a user clocked in to work or not may better inform the computerized system as to where the user is and how the user status should be updated.

In some embodiments, the user status is set according to user activity data received from an accelerometer or gyroscope, which can monitor motion of the personal electronic mobile device and thus of the user carrying the personal electronic mobile device. For example, the motion sensors detect steps taken by the user and determine that the user is walking or running. Thus, the user status may be updated to “GONG FOR A WALK/RUN”. The motion sensors may also work in conjunction with the electronic calendar and GPS, so that direction information may be added to the user status. For example, the electronic calendar identifies that a user has a meeting at a building down the block in 15 minutes and notes that that user is now walking in that direction. Thus, the user status may be updated to “EN ROUTE TO MEETING”. In some embodiments, the context in which the motion sensors detect movement helps determine how a user's status is changed. For example, when the motion sensors detect that a user is running or walking quickly, the computerized system may also check to see if there are any scheduled events to which the user is in danger of being late. If not, then the computerized system may update the user status to read “GOING FOR A WALK/RUN”. If so, then the computerized system may update the user status to simply read “BUSY” so that the user may concentrate on making their next appointment. Motion sensors may also be used to determine if the user is flying, biking, driving, swimming, and the like.

In some embodiments, the computerized system operates by identifying at least one user by the user's personal electronic mobile device. The at least one user is provided with a profile which comprises user related information and the user's status. This profile will be the information available and viewable by other users of the computerized system. The at least one personal electronic mobile device is in contact with at least one server that comprises software for maintaining each profile within the computerized system and also for facilitating communication of the user's status to other users.

At least one sensor provides the data necessary for the servers and associated software to maintain user statuses in real-time. In some embodiments, the data is uploaded to the servers where software analyzes it to determine if any updates to user status must be made. In some embodiments, the data is analyzed on the user's personal electronic mobile device. If current user activity data no longer matches the user status, the user status is updated to reflect the current user activity data.

In some embodiments, users are notified of changes in the user status of other users. For example, a parent may wish to know when a child is no longer identified as “BUSY”, and the computerized system sends an alert to the parent when that change is made to the child's profile. In some embodiments, the computerized system provides a notification to the user that their status is about to be changed. In some embodiments, a user is alerted that the status is about to be changed to “BUSY” from “AVAILABLE”. The user then has the opportunity to accept, reject, or snooze that status change. In some embodiments, a user is alerted that the status is about to be changed from “BUSY” to “AVAILABLE”. In some embodiments, the user is only given the opportunity to accept or snooze this status change, and upon snoozing, will be reminded of the status change after a predetermined amount of time. In some embodiments, the notification merely alerts the user to the status change and does not provide an opportunity to override the status change.

In some embodiments, at least one of a user or a contact is a business or commercial entity. In some embodiments, user status for a business indicates whether the user should expect to hold for the next available individual. In some embodiments, user status for a business includes an expected wait time for a user attempting to call the business. In some embodiments, the system enables a user to enter a call-back queue for the business without having to actually contact the business. The call-back queue then processes the call-back requests in the order in which they were received. In some embodiments, the call-back queue recognizes that a user in the call-back queue is not available to receive the call-back based on that user's user status. In some embodiments, the user remains in the queue until their user status updates to indicate that the user is available, at which point the call-back occurs.

In some embodiments, a user's status includes a preferred method of contact. In some embodiments, a change in a user's status includes a change in the preferred method of contact. For example, a user whose status is “AVAILABLE” may have listed on their user profile in the address book of the present disclosure that their preferred contact number is their mobile telephone number. However, when an electronic calendar identifies that the user is now in a meeting, the user status updates to “BUSY” and the user profile now lists the name and number of the user's administrative assistant as the contact information for that administrative assistant. In some embodiments, the change in user status is also accompanied by a change in user settings on the personal electronic mobile device. For example, the above-identified meeting might cause the user's mobile telephone to switch from full ringer volume to vibrate only. In some embodiments, the system blocks incoming calls for a certain user status. For example, a “BUSY” or “UNAVAILABLE” user status may prevent an individual from completing a call to that user. In some embodiments, a user designates a list of “preferred” or “favorite” contacts who can communicate with the user for a certain user status, such as “BUSY” or “UNAVAILABLE”, while those contacts not on the “preferred” or “favorites” list are prevented from doing so.

In some embodiments, the server includes a profile for a contact that is not a user of the computerized system. In other words, users of the computerized system can still benefit from the advantageous features of this computerized system for contacts that do not participate in the computerized system. For example, a user's address book includes an entry for that user's father; however the father is not a user of the computerized system. However the computerized system is still able to determine when the user's mother calls the user's father, and thus is able to update the profile to “BUSY” in the user's address book when the mother calls the father and back to “AVAILABLE” once the call between the mother and the father is completed.

In some embodiments, the computerized system recognizes that a user's personal electronic mobile device is off and thus that the user status should be changed to “BUSY”. In some embodiments, once the personal electronic mobile device is turned back on, the user status is updated to “AVAILABLE”. In some embodiments, disconnection and reconnection from the computerized system results in the same “BUSY”/“AVAILABLE” status changes as turning off and turning on the personal electronic mobile device.

In some embodiments, the present disclosure is directed to a computerized method for providing “one-click calling” (OCC) of contacts. In some embodiments, the computerized method comprises the step of identifying at least one user, the user having a personal electronic mobile device as described above. In some embodiments, at least one server comprising software for managing user related information and analyzing user activity data is provided. In some embodiments, at least one user is provided with a profile comprising the user related information and user status. In some embodiments, each contact in a user's address book is provided with a profile having user status, even if that contact is not a user of the computerized system. In some embodiments, each individual contact address (telephone number, social media account, instant messaging address, and the like) for contacts that are not users of the computerized system is provided with a user status that is viewable by other users who also have that contact address in their address book as described above.

In some embodiments, each user's profile is made viewable to other users of the computerized system. In some embodiments, a user's profile is only viewable to other users who have been authorized to view the profile. In some embodiments, the user profile is partially viewable by other users.

In some embodiments, the user related information includes a plurality of possible contact addresses including a primary contact address. In some embodiments, the method also includes the step of providing at least one sensor. The at least one sensor collects user activity data which is uploaded to the at least one server and used to determine user status.

In some embodiments, a contact address best suited for contacting the user is then identified. In some embodiments, the contact address best suited for contacting the user is determined by the at least one sensor. In some embodiments, the primary contact address is defined manually. In some embodiments, the user's profile is updated such that the primary contact address is the contact address best suited for contacting the user. In some embodiments, when other users attempt to contact the user, contact is initiated between the user and the other user via the new primary contact address. In some embodiments, the primary contact address is updated according to the time. For instance, a first primary contact address is designated for use in the mornings and a second primary contact address is designated for use in the evenings. User contact addresses that are eligible for use as the new primary contact address include telephone numbers, e-mail addresses, instant messaging accounts, SMS services, social media service, and the like.

In some embodiments, the contact is another user of the computerized system. In some embodiments, the contact does not have an active profile within the computerized system. In some embodiments, a user performing an OCC to a contact only inputs a command to communicate with that contact, and the computerized system of the present disclosure automatically establishes contact between the user and the user's desired contact via the best available method and/or primary contact address. OCC is facilitated by identifying the address best suited for the user to reach the contact via the computerized system. The apparatus best suited for reaching the contact varies depending on the location and behavior of the contact. As identified above, the status of a contact is constantly monitored via at least one sensor. In some embodiments, the at least one sensor monitors a location or movement of the contact. In some embodiments, the at least one sensor is capable of identifying an activity of the contact, such as a gyroscope/accelerometer identifying that the contact is currently running. In some embodiments, the at least one sensor analyzes an electronic calendar of the contact to determine the current activity of the contact, e.g. a dinner reservation informs the sensor that the contact is out of the office, not at home, and is likely busy. In some embodiments, the computerized system analyzes the contact's location and behavior information gathered by the at least one sensor to determine how a user would best reach that contact. Any request by the user to reach that contact is then automatically routed through the best method. For example, if a user attempts to call a contact and the contact happens to be at home, the computerized system could route the call through the contact's home phone number. In another example, if a user attempts to call a contact and the contact happens to be at work, the computerized system could route the call through the contact's work phone number. If the user is at work but motion sensors identify that the user is walking around the office, the computerized system will route the call away from the user's work phone and back to the user's mobile phone. If a user attempts to call a contact and the contact is driving home from work, then the computerized system could route the call through the contact's mobile phone number or open a messaging service to send a text or instant message. In some embodiments, the primary contact address is determined by a SIM card, virtual SIM card, International Mobile Subscriber Identity, Integrated Circuit Card Identifier, and combinations thereof. In these embodiments, a user may switch between various SIM cards, virtual SIM cards, International Mobile Subscriber Identities, or Integrated Circuit Card Identifiers owned by the user, and the system will recognize that the number associated with that new SIM card, virtual SIM card, International Mobile Subscriber Identity, or Integrated Circuit Card Identifier should become the new primary contact address, such that a communication from another user through the system will be routed through new SIM card, virtual SIM card, International Mobile Subscriber Identity, or Integrated Circuit Card Identifier and not the previous one. The user is therefore capable of changing the primary contact address for his or her profile without method of communication or the device for receiving the communication.

In some embodiments, the computerized system provides contact commands for OCC as a single executable for activation by a user. In some embodiments, the executable is an image, a video, a field containing representative alphanumeric information, and the like and combinations thereof. In some embodiments, activation of the single executable by the user is achieved via a cursor, touching a touch screen, voice command, and the like.

In some embodiments, a contact sets preferences to limit the ability of a user to reach them via OCC. In some embodiments, a contact is only reachable via OCC at numbers that the user has in their address book, i.e. if the user does not have a contact's home phone number, the computerized system will not transfer the user's call to the contact's home phone even if the contact is at home. In some embodiments, the contact chooses which numbers are available for access by OCC, i.e. the contact can choose to block transfer of OCCs to their home phone even when they are at home, meaning that a user would need to specifically dial the home phone number should the user desire to reach the contact at that home phone number.

In some embodiments, the present disclosure is directed to a computerized method for porting caller identification, alternatively called “Smart Caller ID”. Broadly, this method includes, in some embodiments, the step of identifying at least one user, the user having a profile comprising user contact information. Personal electronic mobile devices and at least one server comprising software for managing user profiles are provided. The personal electronic mobile device is then informed of its current user and the profile of the current user is applied to the personal electronic mobile device. In some embodiments, this enables a current user to communicate from the personal electronic mobile device and have those communications identified as originating from the current user, even if they are sent from a personal electronic mobile device that does not belong to the current user.

In some embodiments, the step of informing the personal electronic mobile device of the identity of a current user is facilitated by at least one of a user ID and password, facial recognition, fingerprint identification, retinal scan, stride recognition, and the like. Stride recognition refers to the personal electronic mobile device's ability to identify a current user based on the way the user walks, taking into account stride length, frequency, side-to-side motion, and the like.

In some embodiments, the smart caller ID is an image or a video representation of the user recorded or captured by the user at the time of the communication. For example, a user may dial a contact using their smart phone, and then be prompted to take of picture of themselves using the camera application. Once taken and approved, the call with be placed, and the image captured by the camera application will be used as the image on the contact's caller ID. In some embodiments, the smart caller ID allows a user to record a ring tone that will play as the contact's phone rings. For example, a user gets a flat tire on the side of the road and needs to communicate with a contact that they are in trouble and need assistance. The user selects the contact to call, and is then prompted to record a ring tone for that call. The user could then record themselves saying, “This is an emergency, I got a flat tire, please pick up,” which will then play on the contact's phone as it rings. A contact will therefore be able to distinguish the importance of a call prior to the contact even needing to answer the phone.

As discussed above, in some embodiments, the computerized system sets user status and other information automatically based on predefined user preferences and crowd-sourced behavior, or manually in response to user input. In other embodiments, the computerized system monitors a user's behavior and “learns” a user's habits to automatically adjust a user's profile in response to gathered data. In other words, the computerized system recognizes patterns in how a user interacts with the personal electronic mobile device and then automatically implements them as a user preference. For instance, the computerized system might recognize that a user never answers a telephone call when walking home from work. The computerized system will then set the user status to “BUSY” when walking home from work to discourage contacts from attempting to reach the user at that time. The same concept is equally applicable to situations such as being on public transportation, having a scheduled event about to begin a predetermined amount of time in the future, and the like.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

I claim:

1. A computerized system for providing a real-time address book using coordinated electronic components comprising:
at least one user, said at least one user having a personal electronic mobile device;
at least one server comprising software for managing user related information and analyzing user activity data;
a profile including said user related information and a user status, wherein said profile is viewable in the real-time address book;
at least one sensor for collecting said user activity data and uploading said user activity to said at least one server; and
software executing on a computer readable medium for updating said user status in response to analyzed user activity data gathered from said at least one sensor;
wherein said profile is viewable by other users of said computerized system.

2. The computerized system according to claim 1, wherein said at least one sensor includes a phone module, a global positioning system, a gyroscope, an accelerometer, a magnetometer, Wi-Fi module, Bluetooth module, near-field communication module, electronic calendar, and combinations thereof.

3. The computerized system according to claim 1, further comprising a graphic user interface operating on said person electronic mobile device for displaying said profile to said other users.

4. A computerized method for providing a real-time address book using coordinated electronic components, said computerized method comprising:
identifying at least one user, said user having a personal electronic mobile device;
providing at least one server comprising software for managing user related information and analyzing user activity data;
providing said at least one user with a profile comprising said user related information and a user status, said profile being at least partially viewable by other users of the computerized system;
providing at least one sensor;
collecting user activity data identified by said at least one sensor;
uploading said user activity data to said at least one server;
discerning a user status based on said user activity data; and
updating said profile with said user status.

5. The computerized method according to claim 4, wherein said user related information includes current location information.

6. The computerized method according to claim 4, further comprising the step of notifying at least one other user when there is a change in said user status.

7. The computerized method according to claim 4, further comprising the step of requesting authorization from said user to change said user status.

8. The computerized method according to claim 5, further comprising the step of defining said current location information based on a proximity of said user to other users.

9. The computerized method according to claim 4, wherein said user related information includes a user contact field updated in response to updates in said user status, wherein said user contact field reflects one of a user's telephone number, the telephone number of a third-party, or no telephone number, according to user preferences associated with said user status.

10. The computerized method according to claim 4, wherein said at least one sensor includes a phone module, a global positioning system, a gyroscope, an accelerometer, a magnetometer, a Wi-Fi module, a Bluetooth module, a near-field communication module, electronic calendar, and combinations thereof.

11. The computerized method according to claim 10, wherein said at least one sensor identifies that a user is scheduled to attend an event at a specified time and identifies that a plurality of other individuals are attending the meeting, and in response said user status is updated to reflect attendance of said event by said user.

12. The computerized method according to claim 4, wherein said user status includes a location of the user.

13. The computerized method according to claim 4, wherein at least one setting of said personal electronic mobile device is adjusted in response to a change in said user status.

14. The computerized method according to claim 4, further including the step of updating a profile for an individual who is not a user of the computerized system, wherein said updated profile indicates that said individual is on the telephone.

15. A computerized method for providing one-click calling, said computerized method comprising:
identifying at least one user, said user having a personal electronic mobile device;
providing at least one server comprising software for managing user related information and analyzing user activity data;
providing said at least one user with a profile comprising said user related information and a user status, said profile being at least partially viewable by other users of the computerized system, wherein said user related information includes a plurality of possible contact addresses including a primary contact address;
providing at least one sensor;
collecting user activity data identified by said at least one sensor;
uploading said user activity data to said at least one server;
discerning a user status based on said user activity data;
identifying a contact address best suited for contacting said user given a current user status;
updating said profile such that said primary contact address is the contact address best suited for contacting said user;
wherein selecting by the other users of the profile initiates contact between said user and said other users via said primary contact address.

16. The computerized method according to claim 15, wherein said contact address best suited for contacting said user is determined by at least one sensor.

17. The computerized method according to claim 16, wherein said at least one sensor includes a phone module, a global positioning system, a gyroscope, an accelerometer, a magnetometer, a Wi-Fi module, a Bluetooth module, a near-field communication module, electronic calendar, and combinations thereof.

18. The computerized method according to claim 15, wherein at least one other user is prevented from contacting said user via a subset of contact addresses.

19. The computerized method according to claim 18, wherein said plurality of contact addresses includes at least one telephone number, at least one e-mail address, at least one instant messaging account, at least one SMS service, at least one social media service, and the like and combinations thereof.
